(19) United States
(12) Patent Application Publication
(10) Pub. No.: US 2008/0093445 A1
(43) Pub. Date: Apr. 24, 2008

(54) Data ignition card

(76) Inventor: Michael J. Greaves, West Midlands (GB)

Correspondence Address: Galasso & Associates, LP, P.O. Box 26503, Austin, TX, 78755-0503, US

(21) Appl. No.: 11/583,287

(22) Filed: Oct. 19, 2006

(51) Int. Cl. G06K 5/00; G07B 15/02

(52) U.S. Cl. 235/382; 235/384

(57) ABSTRACT

Data Ignition Card is a card with a magnetized strip and/or a microchip embedded in a magnetized strip and an electronic card reader connected to a vehicle's ignition system. To use Data Ignition Card, an individual inserts the card into the card reader prior to starting the vehicle. Information on the card such as insurance and licensing status would be verified. If the status of all information contained on the card was current, the ignition is enabled and the car can then be started and operated in the ordinary manner.

### CROSS REFERENCE TO RELATED APPLICATIONS

This Non-Provisional Patent Application does not claim priority to any U.S. provisional patent application nor any foreign patent application.

### FIELD OF THE DISCLOSURE

The disclosures made herein relate generally to the automotive accessories industry. The invention discussed herein is in the general classification of card readers for automotive ignition.

### BACKGROUND

Automobile drivers have to comply with various laws in order to legally operate their motor vehicles. For instance, a driver needs to have a driver's license to insure that he knows the traffic laws. A driver must also have a safety inspection to verify that the vehicle is safe to operate and that it does not produce emissions that would be harmful to the environment. A registration fee is also required by many states. States also require a driver to have at least liability insurance should a traffic accident occur.

Unfortunately, it is difficult for law enforcement officials to ascertain whether every driver is complying with these various laws. Many uninsured or unlicensed motorists operate vehicles everyday. Currently, law enforcement officials check license, registration, safety inspection status and insurance status only when a vehicle is stopped for another violation. This solution is unsatisfactory because only a small fraction of violators are every caught.

Hence, there is a need in the art for a convenient, inexpensive and effective device for monitoring a driver's compliance with various vehicle operation laws.

### SUMMARY OF THE DISCLOSURE

Data Ignition Card is a card and card reader combination. The card contains information regarding an individual's compliance with various vehicle operation laws and the card reader is capable of reading the information contained on the card.

The principal object of this invention is to provide a device that can be used to monitor an individual's compliance with vehicle operation laws.

Another object of this invention is to provide a device that can be easily installed in motor vehicles.

Another object of this invention is to provide an affordable device for monitoring a driver's compliance with vehicle operation laws.

Yet another object of this invention is to provide a device that can prevent ignition of a vehicle if an individual cannot verify compliance with applicable vehicle operation laws.

### BRIEF DESCRIPTION OF THE DRAWINGS

FIG. 1 depicts a perspective view of the card of the preferred embodiment of the present invention.

FIG. 2 depicts a side view of the card of the preferred embodiment of the invention.

FIG. 3 depicts a perspective view of the card reader of the preferred embodiment of the invention.

### DETAILED DESCRIPTION OF THE DRAWINGS

The preferred embodiment of Data Ignition Card is comprised of at least some of the following: a card with a magnetized strip and a microchip embedded in the magnetized strip and an electronic card reader connected to a vehicle's ignition system.

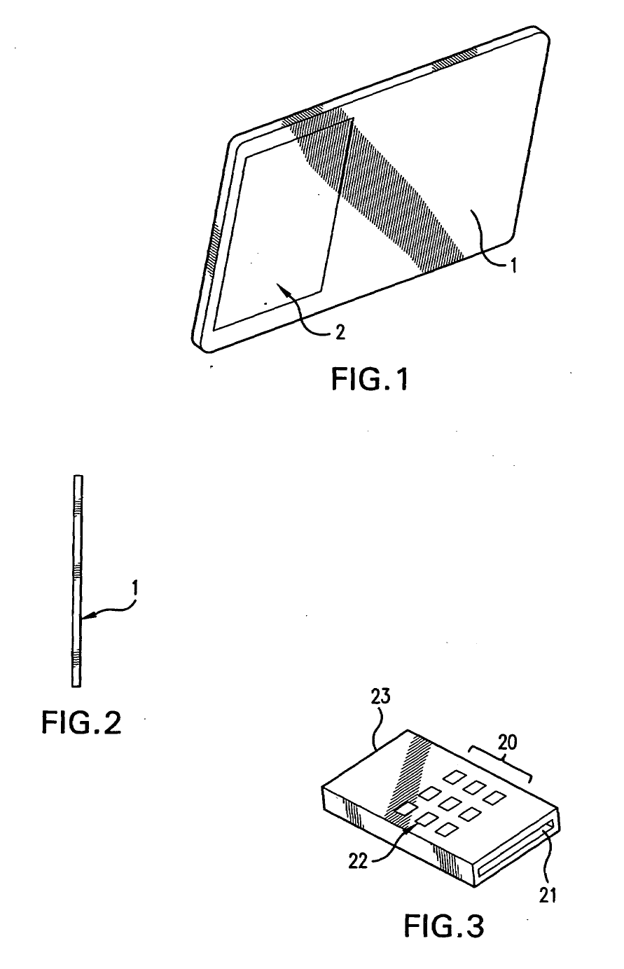

FIG. 1 shows the preferred embodiment of the card 1 of the present invention. The card 1 is rectangular in shape and made of a plastic material. Ideally, the card 1 would be approximately the same size as a credit card. A magnetized strip (not pictured) is located on the back of the card 1. A microchip is embedded into the magnetized strip. The microchip contains information about the user's driver's license and insurance, as well as the vehicle registration and safety inspection status. A photograph 2 of the vehicle's owner would also appear on the front of the card 1.

FIG. 2 depicts a side view of the card 1. The thickness of the card 1 can be seen in greater detail from this view. It is approximately one-eighth of an inch thick.

FIG. 3 depicts a perspective view of the card reader 20 used to verify the information contained on the card. Ideally, the card reader 20 would be mounted to a vehicle's dashboard. The card reader 20 would have a metal housing 23 in the preferred embodiment though a variety of material could be utilized. A slot 21 for insertion of the card is located on the front of the card reader 20. A numeric keyboard 22 is located on top of the card reader 20. The card reader 20 is also attached to the vehicle's ignition system and has an internal memory in the preferred embodiment.

To use Data Ignition Card, the individual would simply insert the card into the slot of the card reader prior to starting the vehicle. The information on the card would be verified and the individual would then type a security code into the card reader to insure the proper vehicle operator was using the vehicle. The internal memory of the card reader would permit it to verify the security code. If the status of all information contained on the card was current and the proper security code was entered, the ignition will be enabled and the car can then be started and operated in the ordinary manner.

In an alternative embodiment of the invention, a wireless internet connection could be utilized by the card reader. In this embodiment, a data bank could be accessed when a card is inserted or swiped through a card reader. The data bank could be maintained by a department of public safety or other administrative agency. Operation of the vehicle could be authorized or declined in much the same manner as a credit card point of sale terminal operates. If all applicable laws are complied with, the ignition system would be enabled through the card reader.

In the preferred embodiment, the information on the card would need to be periodically updated when insurance or a driver's license was renewed. Various locations maintained by a state or other governmental agency could be utilized to either issue new cards or update the information on a previously issued card.

The materials utilized for Data Ignition Card may vary widely but will likely include metals, plastic and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Data Ignition Card can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of plastics or other suitable materials and can be of any color. It should also be obvious that the “card” of the present invention need not be a conventional card and could be any item capable of storing information that can be read by the “card reader.”

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A device for use with a motor vehicle comprising:
(a) a card; and
(b) a card reader that can be operatively connected to an ignition system of a vehicle.

2. The device of claim 1 wherein the card is made of plastic.

3. The device of claim 1 wherein the card is approximately rectangular.

4. The device of claim 1 wherein the card reader has a housing.

5. The device of claim 4 wherein the housing is made of plastic.

6. The device of claim 4 wherein the housing is made of metal.

7. The device of claim 1 wherein a magnetized strip is located on the card.

8. The device of claim 7 wherein a microchip is embedded into the magnetized strip.

9. The device of claim 8 wherein the microchip contains information about compliance with traffic laws.

10. The device of claim 1 wherein a photograph is on the card.

11. The device of claim 1 wherein a keyboard is located on top of the card reader.

12. The device of claim 11 wherein the card reader has an internal memory.

13. A device for use with a motor vehicle comprising:
(a) a card with a magnetized strip and a microchip embedded in the magnetized strip wherein the card is made of plastic and is approximately rectangular and contains a photograph;
(b) a card reader with a housing made of metal that can be operatively connected to an ignition system of a vehicle and is capable of accessing information contained in the card;
(c) a slot on the front of the card reader for insertion of the card; and
(d) a keyboard located on the top of the card reader and an internal memory within the card reader.
